(19) United States
(12) Patent Application Publication
(10) Pub. No.: US 2016/0194243 A1
(43) Pub. Date: Jul. 7, 2016

(54) METHOD FOR MANUFACTURING CHEMICALLY STRENGTHENED GLASS

(71) Applicant: CORNING PRECISION MATERIALS CO., LTD., Chungcheongnam-do (KR)

(72) Inventors: Hoi Kwan Lee, Chungcheongnam-do (KR); Ji Hoon Lee, Chungcheongnam-do (KR); Ho Sam Choi, Chungcheongnam-do (KR); Young Seon Park, Chungcheongnam-do (KR); Jae Chang Lee, Chungcheongnam-do (KR); Jae Ho Lee, Chungcheongnam-do (KR)

(73) Assignee: Corning Precision Materials Co., Ltd., Chungcheongnam-do (KR)

(21) Appl. No.: 14/916,902

(22) PCT Filed: Aug. 26, 2014
(86) PCT No.: PCT/KR2014/007927

§ 371 Date: Mar. 4, 2016

(30) Foreign Application Priority Data
Sep. 6, 2013 (KR) 10-2013-0107016

(51) Int. Cl. C03C 21/00; C03B 33/02

(52) U.S. Cl. CPC C03C 21/002; C03B 33/02

(57) ABSTRACT

The present invention relates to a method for manufacturing chemically strengthened glass and, more specifically, to a method for manufacturing chemically strengthened glass that can enhance the strength of glass. To this end, the present invention provides a method of manufacturing chemically strengthened glass comprising: a primary chemical strengthening step for chemically strengthening a mother glass; a cutting step for cutting the chemically strengthened mother glass into a predetermined size; a paste applying step for applying paste to a cutting plane formed by the cutting step; and a secondary chemical strengthening step for chemically strengthening only the cutting plane by heating the paste, wherein the paste includes alkaline ions having a larger ionic radius than those included in the mother glass.

### BACKGROUND

1. Field

The present disclosure generally relates to a method of fabricating a chemically-strengthened glass substrate. More particularly, the present disclosure relates to a method of fabricating a chemically-strengthened glass substrate able to improve strength thereof.

2. Description of Related Art

Glass products are regarded as essential elements in devices within a wide range of technologies and industrial fields, including various types of visual and optical equipment, such as monitors, cameras, video disk recorders (VDRs), and mobile phones; transportation equipment, such as vehicles; various types of tableware; and construction facilities. Thus, glass products having a variety of physical properties are required to be fabricated and used according to the requirements of various industrial fields.

Recently, the use of a cover glass for a display device is rapidly increasing, along with the usage of capacitive touch panels.

Since the cover glass may be repeatedly touched by the finger of a user, a stylus, or the like, the cover glass is required to have a high level of strength, a smooth surface pleasant to touch, and superior antifouling characteristics providing resistance to dust, sweat, fingerprints, and the like.

A chemically-strengthened glass substrate is generally used as the cover glass for touch panels, and methods of fabricating cover glass-integrated touch panels using such a chemically-strengthened glass substrate may be classified into a sheet-type method and a cell-type method.

The sheet-type method is a method of fabricating touch panels, including: strengthening a large glass sheet; forming a plurality of touch panels on the glass sheet; and cutting and machining the glass sheet to form the plurality of touch panels. The cell-type method is a method of fabricating touch panels, including: cutting and machining a large glass substrate into individual pieces of cover glass according to the intended size of products; strengthening the individual pieces of cover glass; and fabricating touch panels using the strengthened pieces of cover glass.

According to the cell-type method, a touch sensor is formed on a piece of strengthened cover glass corresponding to each cell, and thus the edges of pieces of cover glass are also strengthened to have a high level of strength. However, the cell-type method has a drawback of low productivity.

In contrast, the sheet-type method allows for high productivity, since, in the sheet-type method, touch panels can be fabricated by forming a plurality of touch panels on a single large glass sheet. However, it is difficult to cut and machine the strengthened glass sheet to form a plurality of panels, which is problematic.

In addition, according to the sheet-type method, the operation of cutting the glass sheet into pieces of cover glass may externally expose pristine non-strengthened surfaces (i.e. cut surfaces). Furthermore, in the cutting operation, minute cracks may be formed in these pristine surfaces, thereby lowering the mechanical strength characteristics of cover glass, which is problematic.

FIG. 1 is a conceptual magnified view illustrating a pristine surface of a piece of chemically-strengthened glass. As illustrated in FIG. 1, the pristine surface of chemically-strengthened glass has high levels of surface roughness (SR) and subsurface damage (SSD).

The information disclosed in the Background section is only provided for a better understanding of the background and should not be taken as an acknowledgment or any form of suggestion that this information forms prior art that would already be known to a person having ordinary skill in the art.

### RELATED ART DOCUMENT

Patent Document 1: Korean Patent No. 10-1144264 (May 2, 2012)

### BRIEF SUMMARY

Various aspects of the present disclosure provide a method of fabricating chemically-strengthened glass able to chemically strengthen a pristine surface (i.e. a cut surface) that would otherwise not be chemically strengthened.

According to an aspect, a method of fabricating a chemically-strengthened glass substrate may include: chemically-strengthening a raw glass sheet creating a chemically-strengthening glass sheet; cutting the chemically-strengthened glass sheet into a plurality of glass substrates; applying a paste onto at least one pristine surface of each of the plurality of glass substrates created by cutting the chemically-strengthened glass sheet; and selectively chemically-strengthening the at least one pristine surface by heating the paste. The composition of the paste comprises an alkali ion having an ion radius greater than a radius of an alkali ion of the raw glass sheet.

The paste may be subjected to high-frequency heating in the operation of heating the paste. It is preferable that the paste be subjected to high-frequency heating and resistive heating in the operation of heating the paste.

The operation of heating the paste may be carried out at an ambient temperature of 400° C. or below.

The composition of the paste may include K ions. It is preferable that the K ions be in the form of nitrate.

The composition of the paste may further include ZnO.

The method may further include cleaning the paste off each of the plurality of glass substrates after heating the paste.

In addition, the method may further include forming a deposition film over the chemically-strengthened glass sheet after chemically-strengthening the glass sheet prior to cutting the chemically-strengthened glass sheet.

Furthermore, the method may further include polishing the pristine surfaces after cutting the chemically-strengthened glass sheet before applying the paste to the pristine surfaces.

The glass sheet may be cut into the plurality of glass substrates having a predetermined size using a laser or a scribing device.

As set forth above, a pristine surface can be chemically strengthened in a second selective chemical-strengthening operation, whereby the mechanical characteristics and reliability of chemically-strengthened glass can be improved.

The methods and apparatuses of the present disclosure have other features and advantages that will be apparent from or that are set forth in greater detail in the accompanying drawings which are incorporated herein, and in the following Detailed Description, which together serve to explain certain principles of the present disclosure.

### BRIEF DESCRIPTION OF THE DRAWINGS

FIG. 1 is a conceptual magnified view illustrating a pristine surface of a piece of chemically-strengthened glass; and

FIG. 2 is a flowchart schematically illustrating a method of fabricating a chemically-strengthened glass substrate according to an exemplary embodiment.

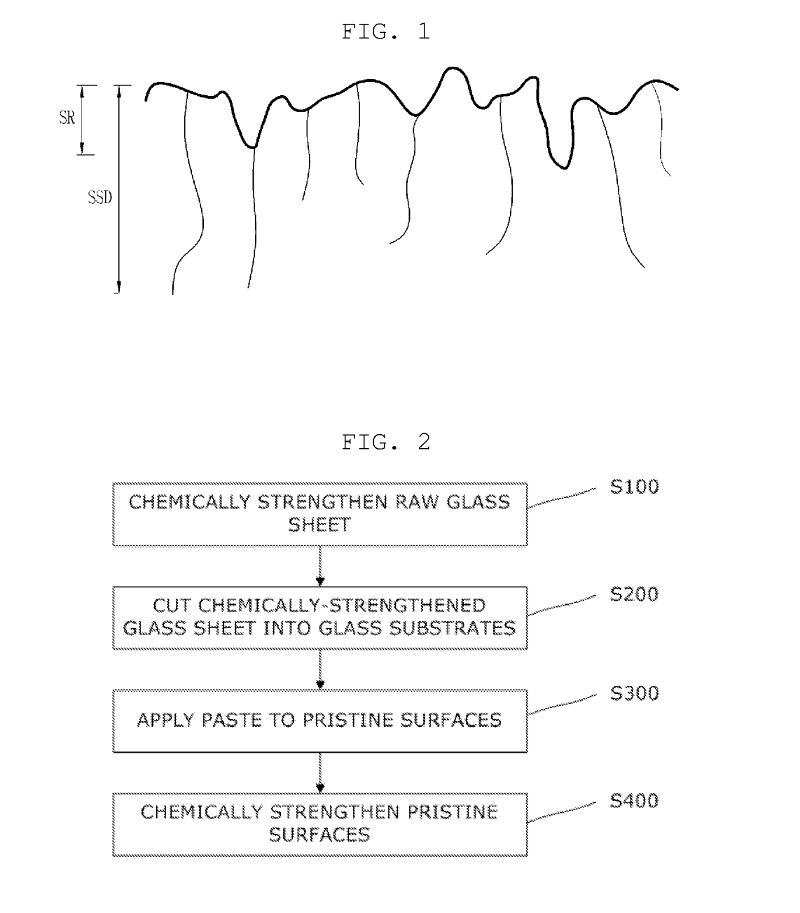

### DETAILED DESCRIPTION

Reference will now be made in detail to a method of fabricating chemically-strengthened glass according to an exemplary embodiment of the present disclosure, embodiments of which are illustrated in the accompanying drawings and described below, so that a person having ordinary skill in the art to which the present disclosure relates could easily put the present disclosure into practice.

Throughout this document, reference should be made to the drawings, in which the same reference numerals and symbols will be used throughout the different drawings to designate the same or like components. In the following description, detailed descriptions of known functions and components incorporated herein will be omitted in the case that the subject matter of the present disclosure is rendered unclear by the inclusion thereof.

FIG. 2 is a flowchart schematically illustrating a method of fabricating a chemically-strengthened glass substrate according to an exemplary embodiment.

As illustrated in FIG. 2, the method of fabricating a chemically-strengthened glass substrate according to the present embodiment includes a first chemical-strengthening operation S100, a cutting operation S200, a paste applying operation S300, and a second chemical-strengthening operation S400.

In order to chemically strengthen a raw glass sheet according to present embodiment, the first chemical-strengthening operation S100 is carried out.

The operation of chemically strengthening the raw glass sheet is carried out using a typical method of fabricating a chemically-strengthened glass sheet. Specifically, the operation of chemically strengthening the raw glass sheet can be carried out by submerging the raw glass sheet in a reaction bath containing a potassium nitrate solution, such that sodium (Na) ions in the raw glass sheet are substituted with potassium (K) ions from the potassium nitrate solution.

The surface of the chemically strengthened glass sheet is subjected to compressive stress, due to the chemical strengthening of the glass sheet, thereby increasing the mechanical strength of the glass sheet.

Afterwards, in the cutting operation S200, the chemically-strengthened glass sheet is cut into pieces having a predetermined size or shape (glass substrates).

When the chemically-strengthened glass sheet is cut into glass substrates, the glass sheet is divided into a plurality of glass substrates, each having one or more (more accurately, two or more) non-strengthened pristine surfaces (i.e. cut surfaces).

Although the cutting operation may be carried out using a laser or a scribing device, this is not intended to be limiting. A variety of other means, such as a water jet, may be used.

After the first chemical-strengthening operation S100, prior to the cutting operation S200, a deposition film may be formed over the chemically-strengthened glass sheet.

In the film deposition operation, an operation of forming touch sensors on the glass sheet may be carried out. Specifically, after an indium tin oxide (ITO) thin film is deposited on the glass sheet, a patterning operation or an operation of forming a bezel for the pieces of cover glass may be undertaken.

As described above, the deposition film required for the fabrication of a plurality of touch panels is formed over the strengthened glass sheet using a single process, thereby improving the productivity of the fabrication of touch panels.

Afterwards, in the paste applying operation S300, a paste is applied to the pristine surfaces created by the cutting operation S200.

The paste is applied to the pristine surfaces created by the cutting operation S200 in order to chemically strengthen the pristine surfaces. The composition of the paste may include an alkali ion having an ion radius greater than the ion radius of an alkali ion in the raw glass sheet prior to the chemical strengthening operation.

In general, the paste preferably contains K ions since chemical strengthening is carried out by exchanging Na ions of glass with K ions having a larger ion radius. Chemical strengthening through the ion exchange of Mg²⁺ or Ca²⁺ is not properly carried out, since polyvalent ions, except for alkali metals, have difficulty in moving in glass. In addition, an excessively-large ion radius also obstructs ion diffusion in glass. Thus, chemical strengthening through the ion exchange of Rb⁺ or Cs⁺ is not properly carried out although the ion valency thereof is equally 1.

It is more preferable that K ions be contained in the form of nitrate in the paste.

In addition, the composition of the paste according to the present embodiment may further include ZnO.

When the paste is heated, the paste may be liquefied to flow to the portions other than the pristine portions (cut portions). ZnO contained in the paste may allow the paste to remain in a slurry state even after the paste is heated.

After the cutting operation S200, prior to the paste applying operation S300, an operation of polishing the pristine surfaces may be added.

The operation of polishing the pristine surfaces may machine the corners of the glass substrates into a desirable shape. In addition, the roughness of the pristine surfaces may be lowered, and minute cracks occurred in the cutting operation may be removed.

Afterwards, in the second chemical-strengthening operation S400, only the pristine surfaces are chemically strengthened by heating the paste.

When the paste is heated, the alkali ion contained in the paste is exchanged with the alkali ion in glass, whereby the pristine surfaces are chemically strengthened.

It is preferable that the paste be subjected to high-frequency heating in the second chemical-strengthening operation S400. The paste can be heated to a high temperature by high-frequency heating since the paste has a high degree of high-frequency energy absorption. In contrast, the other portions of the pieces of glass uncovered with the pasted are substantially free of the influence of a high frequency, and thus are not heated by high-frequency heating. Accordingly, the compressive stress formed in the portions other than the pristine surfaces is not relieved. High-frequency heating may be carried out using a variable or fixed high frequency less than 50 GHz.

It is more preferable that the second chemical-strengthening operation S400 include resistive heating carried out on the paste in addition to high-frequency heating, whereby the pristine surfaces are chemically strengthened.

High-frequency heating and resistive heating carried out on the paste can increase the speed at which the pristine surfaces are chemically strengthened through ion exchange. Here, the resistive heating may be infrared (IR) heating.

The second chemical-strengthening operation S400 may be carried out at an ambient temperature of 400° C. or below. When the ambient temperature exceeds 400° C., the compressive stress formed in the portions other than the pristine surfaces may be relieved, whereby strengthening may be lessened.

A potassium nitrate (KNO₃) paste was applied onto a piece of non-strengthened soda-lime silicate glass substrate, and then the glass substrate was heated. Table 1 represents compressive stress and the depth of layer (DOL) of compressive-stressed layers according to heating conditions of the paste. IR heating was carried out at a constant temperature of 350° C., but high-frequency irradiation times and the outputs of a high-frequency heating device (Mgt) are differently set. Here, the high-frequency heating device used was a high-frequency heating device able to generate a frequency of up to 60 GHz.

TABLE 1

| Mgt output | Irradiation time | Compressive stress | | DOL |
|---|---|---|---|---|
| 50% | 10 mins | 385~424 | MPa | 9.6~10.8 μm |
| 80% | 3 mins | 332 | MPa | — |
| | 5 mins | 220~272 | MPa | 10~11 μm |
| 100% | 3 mins | 309 | MPa | 12~13.8 μm |

As illustrated in Table 1, when the soda-lime silicate glass was strengthened using the paste according to an exemplary embodiment of the present disclosure, compressive stress ranging from about 220 MPa to about 424 MPa and a compressive stress layer having a DOL ranging from about 9.6 μm to about 13.8 μm were obtained in the soda-lime silicate glass. Although the results are slightly less than compressive stress of about 500 MPa and the depth of about 15 μm of a compressive stress layer obtained by the first chemical-strengthening operation, the resultant strength may be sufficient to protect the edge portions of the glass substrate.

In addition, the present disclosure may further include a cleaning operation of cleaning the paste off the chemically strengthened glass substrate after the second chemical-strengthening operation S400.

In the cleaning operation, the paste left on the pristine surfaces after the second chemical-strengthening operation is cleaned using a cleaning solution. The cleaning solution used here may be water or the like.

As set forth above, in the present disclosure, the overall mechanical characteristics of chemically-strengthened glass can be improved by chemically-strengthening a glass sheet, cutting the chemically-strengthened glass sheet into pieces, and selectively chemically-strengthening pristine surfaces created by the cutting operation.

The foregoing descriptions of specific exemplary embodiments of the present disclosure have been presented with respect to the drawings. They are not intended to be exhaustive or to limit the present disclosure to the precise forms disclosed herein, and many modifications and variations are obviously possible for a person having ordinary skill in the art in light of the above teachings.

It is intended therefore that the scope of the present disclosure not be limited to the foregoing embodiments, but be defined by the Claims appended hereto and their equivalents.

What is claimed is:

1. A method of fabricating a chemically-strengthened glass substrate, comprising:
chemically-strengthening a raw glass sheet creating a chemically-strengthened glass sheet;
cutting the chemically-strengthened glass sheet into a plurality of glass substrates;
applying a paste onto at least one pristine surface of each of the plurality of glass substrates created by cutting the chemically-strengthened glass sheet, a composition of the paste comprising an alkali ion having an ion radius greater than an ion radius of an alkali ion which a composition of the raw glass sheet comprises; and
selectively chemically-strengthening the at least one pristine surface by heating the paste, creating a chemically-strengthened glass substrate.

2. The method of claim 1, wherein heating the paste comprises high-frequency heating the paste.

3. The method of claim 2, wherein heating the paste comprises high-frequency heating and resistive heating the paste.

4. The method of claim 1, wherein heating the paste is carried out at an ambient temperature of 400° C. or below.

5. The method of claim 1, wherein the composition of the paste comprises K ions.

6. The method of claim 5, wherein the K ions are in a form of nitrate.

7. The method of claim 1, wherein the composition of the paste further comprises ZnO.

8. The method of claim 1, further comprising cleaning the paste off the chemically-strengthened glass substrate after heating the paste.

9. The method of claim 1, further comprising forming a deposition film over the chemically-strengthened glass sheet after chemically-strengthening the raw glass sheet prior to cutting the chemically-strengthened glass sheet.

10. The method of claim 1, further comprising polishing the at least one pristine surface after cutting the chemically-strengthened glass sheet before applying the paste onto the at least one pristine surface.

11. The method of claim 1, wherein cutting the chemically-strengthened glass sheet is performed using a laser or a scribing device.
